(19) United States
(12) Patent Application Publication
(10) Pub. No.: US 2002/0105860 A1
(43) Pub. Date: Aug. 8, 2002

(54) Watch case incorporating a passage for engagement with a bracelet

(75) Inventor: Antonio Gensini, Sesto Fiorentino (IT)

Correspondence Address: BROWDY AND NEIMARK, P.L.L.C., 624 NINTH STREET, NW, SUITE 300, WASHINGTON, DC, 20001-5303, US

(73) Assignee: Nomination di Antonio e Paolo Gensini s.n.c., Florence (IT)

(21) Appl. No.: 10/062,486

(22) Filed: Feb. 5, 2002

(30) Foreign Application Priority Data
Feb. 5, 2001 (IT) FI2001U000012

(51) Int. Cl. A44C 5/00; G04B 37/00

(52) U.S. Cl. 368/281

(57) ABSTRACT

A watch comprising a case (1) defining a housing (2), a movement (3) placed within the housing (2), a bottom piece (6) to close the housing (2) arranged at the back of the movement (3) and means for engagement of the case (1) with a bracelet (13), in which the case (1) has a base (1a) that extends axially rearwards beyond the bottom piece (6). A passage (12) for the insertion of the bracelet (13) diametrically crosses the base (1a). At least a tract of the passage (12) has a cross section with an outline that is equal to that of the bracelet, so that the bracelet (13) can slide in the passage (12) only when it becomes subjected to a slight axial force, and the watch (13) remains in position when the bracelet is worn.

### FIELD OF THE INVENTION

The present invention concerns the field of jewellery and costume jewellery products and, more precisely, has as its object a finding utilizable in connection with bracelets, particularly but not exclusively of the type made up of modular box-shaped links.

### BACKGROUND OF THE INVENTION

Among the known bracelets used in jewellery and costume jewellery there are those of the type with a catenation of box-shaped links, each having a quadrilateral outline and joined to its neighbour in an articulated manner, thus forming a closed structure. The engagement between the individual links can be realized by means of anyone of the known systems, e.g. by using one or more cores made of rubber or other elastic material or by means of articulated snap-type joints between each link and the next.

As a general rule, the outer surfaces of at least some of the links are provided with appropriate ornamental motives that are added by means of plating, enamelling or other techniques. Bracelets of the aforementioned type that proved particularly successful in commerce are those in which said motives consist of letters of the alphabet, so that appropriate choice of the letters borne by adjacent links makes it possible to form meaningful words that can be read along the outer perimeter of the bracelet. Typical is the case in which said words are proper names, so that the bracelet becomes personalized by displaying the name of its owner.

The joint between the links is usually realized by means of a connecting system that is both economic and structurally simple, thus permitting a quick and easy assembly of the bracelet. Consequently, given an appropriate stock of individual components, the retailer himself can assemble the bracelet and is thus in a position to offer his customer a bracelet bearing any name, word or phrase he may desire. The customer can thus be offered a wide range of personalization possibilities with only a limited stock of links.

Not least in view of the great commercial success enjoyed by the type of bracelet just described, there is a widely felt need for finding new esthetic and functional solutions that offer the customer even greater possibilities of personalizing the bracelet and thus generate the motivation for new purchases. On the other hand, such solutions must preserve the simplicity and economy of the jointing system to ensure that the bracelet can be rapidly assembled even by an unskilled person (generally the retailer or even the bracelet owner himself) and without having to use special tools and/or supplementary attachment or connecting elements. Furthermore, said system must neither penalize the appearance of the article nor cause any kind of discomfort to its wearer.

### SUMMARY OF THE INVENTION

The object of the present invention is therefore to provide an original solution that—especially but not exclusively when applied to bracelets made up of modular box-shaped links—will make it possible to satisfy the aforementioned need for personalization while yet making use of an assembly system that fully respects the design constraints that have just been outlined.

According to the invention this object is achieved by means of a watch comprising a case defining a housing, a movement located within the housing, a bottom piece to close the housing arranged at the back of the movement and means for engaging the case with a bracelet, wherein the case comprises a base that extends axially rearwards beyond the bottom piece, said engagement means comprising a passage for the insertion of the bracelet, the passage being formed diametrically in said base. The cross section of the passage, at least in a tract of the latter, has an outline that is substantially equal to that of the bracelet, so that a slight force is needed to make the bracelet slide in the passage, and the watch remains in position when the bracelet is worn.

### BRIEF DESCRIPTION OF THE DRAWINGS

The characteristics and advantages of the watch with case incorporating a passage for engagement with a bracelet in accordance with the present invention will be brought out more clearly by the description given below of a particular embodiment thereof, which is to be considered as an example and not limitative in any way, said description making reference to the attached drawings of which:

FIG. 1 shows a top plan view of a segment of a bracelet made up of modular links to which there is attached a watch in accordance with the invention;

FIG. 2 shows a side elevation of the watch of FIG. 1 as seen in the direction of the arrow II, the bracelet being omitted for the sake of clarity;

FIG. 3 shows a side elevation, partially broken, of the watch as seen in the direction of the arrow III, the bracelet being partly omitted.

### DETAILED DESCRIPTION OF THE PREFERRED EMBODIMENT

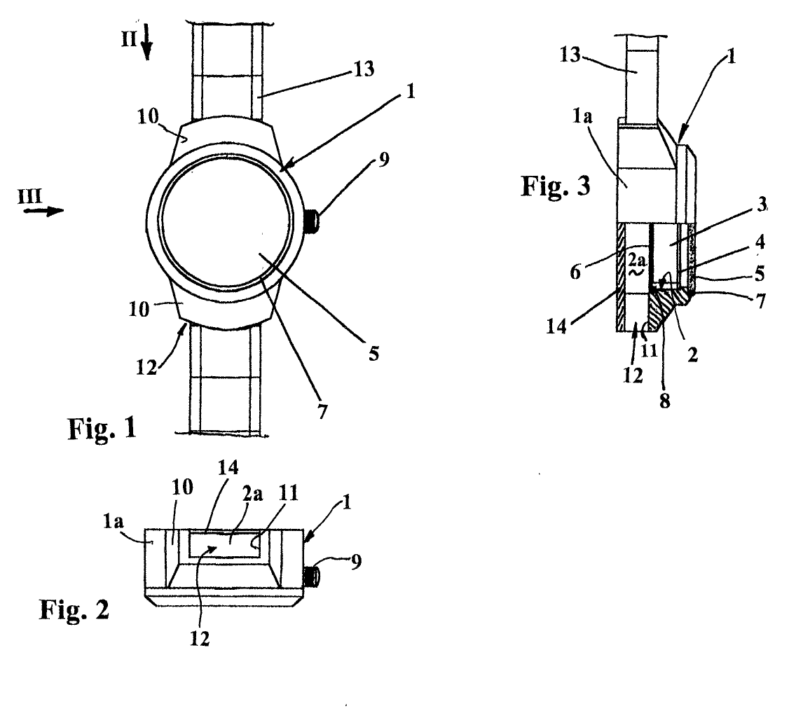

Referring to FIG. 1, the watch in accordance with the invention comprises a case 1 having a generally cylindrical shape and conventionally defining a housing 2 intended for containing a movement 3. Still conventionally, the housing 2 is closed on the front side of the movement 3 by a dial 4 and a watch glass 5 and on the rear side of the movement by a removable bottom piece 6. The dial 4 and the bottom piece 6 insulate the movement 3 in a watertight manner thanks to sealing rings indicated, respectively, by the reference numberals 7 and 8. A crown 9 for adjusting the watch extends radially from the movement 3 through the case 1.

According to the invention, the case 1 extends axially in a rearward direction beyond the bottom piece 6 so as to form a rear base 1a, in correspondence of which a rearward segment 2a of the housing 2 is defined. From diametrically opposite points of the base 1a, namely those defined by the meridian axis on the dial 4, there protrude two radial projections 10.

Formed within the projections 10 there are respective seatings 11 which, together with the rearward segment 2a of the housing 2, generate a passage 12 that crosses the base 1a in a diametral direction and is closed at the rear by a snap-fitted cover 14. The cross-section of a seating 11 has an outline equal to the outline of the cross-section of a bracelet 13, which in the illustrated embodiment is of the type made up of modular box-shaped links, so that the bracelet slide within the passage 12 only when it becomes subjected to a slight force.

In use, therefore, the case 1 is mounted on the bracelet 13 by manually pushing one end of the bracelet into the passage 12, until the watch comes to be situated about halfway along the length of the bracelet. The friction between the bracelet 13 and the seatings 11 ensures that the watch will remain in position when the bracelet is worn without being displaced as a result of the wearer's movements. The watch contacts the wrist of the wearer with the outer, plane face of cover 14, thus without the annoyance that would result from the provision of protruding engagement elements.

Removal of the rear cover 14 of the base 1a, which can be carried out with the help of a common lever, makes it possible to access to the bottom piece 6 and, detaching the latter in the conventional manner, to the movement 3 for any necessary maintenance and/or repair operations.

Thanks to the invention it therefore becomes possible to enrich the esthetics and the functionality of every type of ornamental bracelet, especially those made up of modular box-shaped links, whose personalization possibilities become further enhanced without in any way interfering with the requirement that they should be capable of being quickly and easily assembled. Indeed, assembly is an altogether elementary operation that can be performed by any purchaser or user without the use of any special instruments or tools. The absence of any supplementary fixing components over and above the mere case and bracelet assembly makes a significant contribution to both the practicality of the solution and to containing its cost.

Dealers can keep in stock a variety of watches of different esthetic configurations, leaving the customer free to choose an appropriate combination of watch and bracelet at the moment of purchase. The watch in accordance with the invention can also be offered for sale by itself, thus enabling the purchaser to use it with bracelets already in his/her possession.

Not only is the appearance of the article not damaged in any way by the presence of the watch, but is rather rendered very pleasing by the clean and simple lines and the compactness of the case-bracelet combination.

Variants and/or modifications could be introduced into the watch with case incorporating a passage for engagement with a bracelet in accordance with the present invention without for this reason going beyond the protection limits of the invention as defined by the claims hereinbelow.

1. A watch comprising a case (1), a housing (2) defined by said case (1), a movement (3) placed within said housing (2), a bottom piece (6) to close said housing (2) arranged at the back of said movement (3) and means for engaging a bracelet (13) to said case (1), wherein said case (1) comprises a base (1a) that extends axially rearwards beyond said bottom piece (6), said engagement means comprising a passage (12) for the insertion of said bracelet (13), said passage (12) being formed diametrically in said base (1a), the cross section of said passage (12), at least in a tract of the latter, having an outline that is substantially equal to that of said bracelet (13), whereby a slight force is needed to make the bracelet slide in the passage, and the watch remains in position when the bracelet is worn.

2. A watch according to claim 1, wherein said passage (12) comprises a rearward segment (2a) of said housing (2) and seatings (11) formed within projections (10) that protrude radially from diametrically opposite points of said base (1), the cross-section of a seating (11) having an outline equal to the outline of the cross-section of said bracelet (13).

3. A watch according to claim 2, wherein said passage (12) is closed at the rear by a cover (14) that engages with said base (1a) of said case (1) by means of a snap fit.
